(19) United States
(12) Patent Application Publication
(10) Pub. No.: US 2026/0152442 A1
(43) Pub. Date: Jun. 4, 2026

(54) SILICON NITRIDE SINTERED BODY AND WEAR-RESISTANT MEMBER USING SAME

(71) Applicant: NITERRA MATERIALS CO., LTD., Yokohama-shi (JP)

(72) Inventors: Akimasa YUASA, Yokohama (JP); Naoto HOUTSUKI, Taito (JP); Rena ASO, Yokohama (JP); Yuta TAKEUCHI, Yokohama (JP); Katsuyuki AOKI, Yokohama (JP)

(73) Assignee: NITERRA MATERIALS CO., LTD., Yokohama-shi (JP)

(21) Appl. No.: 19/460,613

(22) Filed: Jan. 27, 2026

Related U.S. Application Data
(63) Continuation of application No. PCT/JP2024/029706, filed on Aug. 21, 2024.

(30) Foreign Application Priority Data
Aug. 24, 2023 (JP) 2023-136454

(51) Int. Cl. C04B 35/584

(52) U.S. Cl. CPC C04B 35/584; C04B 2235/3222; C04B 2235/3878; C04B 2235/3882; C04B 2235/3886; C04B 2235/61; C04B 2235/767; C04B 2235/786

(57) ABSTRACT

According to an embodiment, XRD analysis results of any cross section of a silicon nitride sintered body satisfy 0.001≤(I_{20.5°}+I_{22.8°}+I_{34.3°}+I_{38.7°})/(I_{33.6°}+I_{36.1°})≤0.300 and satisfy 0.002≤(I_{31.8°}+I_{37.2°})/(I_{33.6°}+I_{36.1°})≤0.100. I_{20.5°}, I_{22.8°}, I_{34.3°}, and I_{38.7°} are maximum peak intensities corresponding to hexagonal α-SiAION crystals detected respectively at 20.5±0.3°, 22.8±0.3°, 34.3±0.3°, and 38.7±0.3°. I_{33.6°} and I_{36.1°} are maximum peak intensities corresponding to β-Si₃N₄ crystals detected respectively at 33.6±0.3° and 36.1±0.3°. I_{31.8°} and I_{37.2°} are maximum peak intensities corresponding to R₂Si₃O₃N₄ crystals detected respectively at 31.8±0.3° and 37.2±0.3°. R is a rare-earth element.

### CROSS-REFERENCE TO RELATED APPLICATIONS

This is a continuation application of International Patent Application PCT/JP2024/029706, filed on Aug. 21, 2024. This application also claims priority to Japanese Patent Application No. 2023-136454, filed on Aug. 24, 2023. The entire contents of which are incorporated herein by reference.

### FIELD

Embodiments described herein relate generally to a silicon nitride sintered body and a wear-resistant member using a silicon nitride sintered body.

### BACKGROUND

Silicon nitride sintered bodies have excellent mechanical properties (hardness, toughness, strength, etc.). Taking advantage of such characteristics, silicon nitride sintered bodies are used in wear-resistant members and substrates for semiconductor devices. Wear-resistant members include bearing balls, friction stir welding tool members, engine parts, etc. In recent years, demand has been increasing for silicon nitride sintered bodies used in bearing balls of electric vehicle motors.

The use of inexpensive silicon nitride powders is being tried in the mass production of silicon nitride sintered bodies. Silicon nitride powders are raw materials of silicon nitride sintered bodies, and are made mainly by direct nitriding or imide decomposition. A silicon nitride powder manufactured with imide decomposition has few impurities, but is expensive. On the other hand, direct nitriding is inexpensive compared to imide decomposition, but results in more impurities in the silicon nitride powder.

For example, JP 5732037 (Patent Literature 1) discusses a silicon nitride powder manufactured by direct nitriding. The silicon nitride powder is used in a silicon nitride sintered body. According to Patent Literature 1, the silicon nitride powder includes not less than 10 wtppm and not more than 3,500 wtppm of impurity iron. The silicon nitride sintered body described in Patent Literature 1 has a Vickers hardness HV of about 1,450, and the mechanical strength is insufficient.

In JP 6334413 (Patent Literature 2), the XRD peak ratio of hexagonal α-SiAION crystals to β-Si₃N₄ crystals is controlled. In Patent Literature 2, the XRD peak ratio of at least one of Y₂Si₃O₁₂N (the H-phase), YSiO₂N (the K-phase), or Y₂Si₃O₃N₄ is controlled. According to Patent Literature 2, the Vickers hardness HV of the silicon nitride sintered body is about 1,500 to 1,600.

### BRIEF DESCRIPTION OF THE DRAWINGS

FIG. 1 shows an example of XRD analysis results of a silicon nitride sintered body according to an embodiment;

FIG. 2 shows an example of a bearing ball according to an embodiment; and

FIG. 3 shows an example of a bearing.

### DETAILED DESCRIPTION

According to an embodiment, XRD analysis results of any cross section of a silicon nitride sintered body satisfy 0.001≤(I_{20.5°}+I_{22.8°}+I_{34.3°}+I_{38.7°})/(I_{33.6°}+I_{36.1°})≤0.300 and satisfy 0.002≤(I_{31.8°}+I_{37.2°})/(I_{33.6°}+I_{36.1°})≤0.100. I_{20.5°}, I_{22.8°}, I_{34.3°}, and I_{38.7°} are maximum peak intensities corresponding to hexagonal α-SiAION crystals detected respectively at 20.5±0.3° 22.8±0.3°, 34.3±0.3°, and 38.7±0.3°. I_{33.6°} and I_{36.1°} are maximum peak intensities corresponding to β-Si₃N₄ crystals detected respectively at 33.6±0.3° and 36.1±0.3°. I_{31.8°} and I_{37.2°} are maximum peak intensities corresponding to R₂Si₃O₃N₄ crystals detected respectively at 31.8±0.3° and 37.2±0.3°. R is a rare-earth element.

First, the conditions under which the XRD analysis is performed will be described. The XRD apparatus is the D8 ADVANCE manufactured by BRUKER, or an apparatus having equivalent performance. The measurement surface is any cross section of the sintered body. A polished surface that is polished to a surface roughness Ra of not more than 1 μm is used as the measurement surface. A Cu target (Cu-Kα) is used in the XRD analysis; and the measurements are performed using a tube voltage of 40 kV, a tube current of 40 mA, a scan speed of 2.0°/min, a slit (RS) of 0.15 mm, and a scanning range (2θ) of 10° to 60°. A wider range may be measured as long as the scanning range (2θ) includes 10° to 60°. The most intense peak refers to a maximum peak intensity among the peak intensities appearing within a specific range.

The scanning range is set to 10° to 60° because intense peaks of the silicon nitride sintered body appear within this range. The silicon nitride sintered body according to the embodiment may have other peaks within the range of 10° to 60° in addition to the peaks specified in the specification. The silicon nitride sintered body according to the embodiment also may have peaks outside the range of 10° to 60°.

The maximum peak intensities detected at 20.5±0.3°, 22.8±0.3°, 34.3±0.3°, and 38.7±0.3° are respectively taken as I_{20.5°}, I_{22.8°}, I_{34.3°}, and I_{38.7°}. The peaks that are detected in these ranges correspond to hexagonal α-SiAION crystals. It is sufficient for a peak to be present in at least one range among 20.5±0.3°, 22.8±0.3°, 34.3±0.3°, and 38.7±0.3°. More favorably, peaks are present in all of 20.5±0.3°, 22.8±0.3°, 34.3±0.3°, and 38.7±0.3°. When a peak is not detected in one range, the maximum peak intensity I in the one range is zero.

The peak intensities are affected not only by the amount present and the crystal composition, but also the crystallite size and orientation. When these four peaks are detected, it indicates not only good crystallinity but also good orientation of hexagonal α-SiAION crystals. Peaks that correspond to hexagonal α-SiAION crystals may be present in ranges other than the four ranges of 20.5±0.3°, 22.8±0.3°, 34.3±0.3°, and 38.7±0.3°. Herein, “orientation” refers to the crystal dispersibility inside the sintered body. By dispersing the crystals uniformly in various directions inside the sintered body, various characteristics of the silicon nitride sintered body can be improved.

The maximum peak intensities detected at 33.6±0.3° and 36.1±0.3° are respectively taken as I_{33.6°} and I_{36.1°}. The peaks that are detected in these ranges correspond to β-Si₃N₄ crystals. Peaks are detected at 33.6±0.3° and 36.1±0.3° when β-Si₃N₄ crystals are present in the sintered body. In other words, when peaks are detected at 33.6±0.3° and 36.1±0.3°, it means that β-Si₃N₄ crystals are present in the sintered body. Peaks that correspond to β-Si₃N₄ crystals may be present in ranges other than the two ranges of 33.6±0.3° and 36.1±0.3°. The reason for using the two peak intensities of I_{33.6°} and I_{36.1°} is to relax the effects of peak intensity changes due to crystal orientation.

The maximum peak intensities detected at 31.8±0.3° and 37.2±0.3° are respectively taken as I_{31.8°} and I_{37.2°}. The peaks that are detected in these ranges correspond to R₂Si₃O₃N₄ crystals. “R” in R₂Si₃O₃N₄ crystals represents a rare-earth element. The rare-earth element is at least one selected from the group consisting of yttrium and lanthanoid elements. R₂Si₃O₃N₄ also is referred to as melilite. It is sufficient for at least one of I_{31.8°} or I_{37.2°} to be detected, and it is more favorable for both to be detected. These two peaks being detected indicates not only that the crystallinity of the R₂Si₃O₃N₄ crystals is good, but also that the orientation of the R₂Si₃O₃N₄ crystals is good.

In the silicon nitride sintered body according to the embodiment, the XRD peaks based on hexagonal α-SiAION crystals, β-Si₃N₄ crystals, and R₂Si₃O₃N₄ crystals satisfy the following Formulas 1 and 2.

$$0.001 \leq ( {I}_{20.5 °} + {I}_{22.8 °} + {I}_{34.3 °} + {I}_{3 8.7 °} ) / ( {I}_{33.6 °} + {I}_{3 6.1 °} ) \leq 0 \text{.300} \qquad Formula 1$$

$$0. 2 \leq ( {I}_{31.8 °} + {I}_{3 7.2 °} ) / ( {I}_{33.6 °} + {I}_{36.1 °} ) \leq 0.100 \qquad Formula 2$$

Formula 1 represents the condition of the ratio of the maximum peak intensities based on hexagonal α-SiAION crystals relative to the maximum peak intensities based on β-Si₃N₄ crystals. The ratio being not less than 0.001 indicates that hexagonal α-SiAION crystals and β-Si₃N₄ crystals are present. The ratio being not more than 0.300 indicates that β-Si₃N₄ crystals are present and the amount of hexagonal α-SiAION crystals relative to the amount of β-Si₃N₄ crystals is sufficiently small.

Many hexagonal α-SiAION crystals have an aspect ratio of less than 2. Many β-Si₃N₄ crystals have long columnar shapes having an aspect ratio of not less than 2. The presence of hexagonal α-SiAION crystals in the gaps between the long columnar β-Si₃N₄ crystals is effective to improve the characteristics of the sintered body. Crystal grains that have different aspect ratios are mixed in a structure in which hexagonal α-SiAION crystals and β-Si₃N₄ crystals are mixed. For hexagonal α-SiAION crystals, the maximum peak intensities I_{20.5°}, I_{22.8°}, I_{34.3°}, and I_{38.7°} are affected not only by the amount present, but also by the orientation. Formula 1 being satisfied indicates that the orientation of the hexagonal α-SiAION crystals and the orientation of the β-Si₃N₄ crystals are good. By hexagonal α-SiAION crystals being present with good orientation in the gaps of the long columnar β-Si₃N₄ crystals, the wear resistance of the sintered body can be improved. α-SiAION crystals also may have a cubic crystal structure. In the silicon nitride sintered body according to the embodiment, it is favorable for XRD peaks based on cubic α-SiAION crystals not to be detected.

If the ratio (I_{20.5°}+I_{22.8°}+I_{34.3°}+I_{38.7°})/(I_{33.6°}+I_{36.1°}) is less than 0.001, the amount of hexagonal α-SiAION crystals relative to the amount of β-Si₃N₄ crystals is insufficient. If the ratio is greater than 0.300, the amount of β-Si₃N₄ crystals relative to the amount of hexagonal α-SiAION crystals is insufficient. As a result, the characteristics of the sintered body may degrade. It is therefore favorable for the ratio (I_{20.5°}+I_{22.8°}+I_{34.3°}+I_{38.7°})/(I_{33.6°}+I_{36.1°}) to be within the range of not less than 0.001 and not more than 0.300, and more favorably within the range of not less than 0.010 and not more than 0.100.

When the cross section of the silicon nitride sintered body is observed with a scanning electron microscope (SEM), there are cases where the aspect ratio of the β-Si₃N₄ crystals appears to be less than 2 due to the orientation direction. There are also cases where the aspect ratio of the hexagonal α-SiAION crystals present in the gaps between the β-Si₃N₄ crystals appears to be not less than 2. Based on only a SEM photograph of the cross section, it is difficult to discriminate between hexagonal α-SiAION crystals and β-Si₃N₄ crystals and determine the crystal orientations of the hexagonal α-SiAION crystals and the β-Si₃N₄ crystals. Therefore, the detection of XRD peaks is effective to evaluate the orientation of the hexagonal α-SiAION crystals and the orientation of the β-Si₃N₄ crystals.

Formula 2 represents the condition of the ratio of the maximum peak intensities based on R₂Si₃O₃N₄ crystals relative to the maximum peak intensities based on the β-Si₃N₄ crystals. Hereinafter, R₂Si₃O₃N₄ crystals also are referred to as melilite crystals. Formula 2 being satisfied indicates that both melilite crystals and β-Si₃N₄ crystals are present inside the sintered body. For melilite crystals, the maximum peak intensities I_{31.8°} and I_{37.2°} also are affected by the orientation. Formula 2 being satisfied indicates that the orientation is good for both melilite crystals and β-Si₃N₄ crystals.

Melilite crystals are present at the grain boundaries of the crystal structure made by the hexagonal α-SiAION crystals and the β-Si₃N₄ crystals. Formula 2 being satisfied indicates that the amount present, crystallinity, and orientation of the melilite crystals are good. The wear resistance of the silicon nitride sintered body can be further improved thereby.

If the ratio (I_{31.8°}+I_{37.2°})/(I_{33.6°}+I_{36.1°}) is less than 0.002, the amount of melilite crystals relative to the amount of β-Si₃N₄ crystals is insufficient. If the ratio of Formula 2 is greater than 0.100, the amount of β-Si₃N₄ crystals relative to the amount of melilite crystals is insufficient. As a result, the characteristics of the sintered body may degrade. It is therefore favorable for the ratio (I_{31.8°}+I_{37.2°})/(I_{33.6°}+I_{36.1°}) to be within the range of not less than 0.002 and not more than 0.100, and more favorably within the range of not less than 0.020 and not more than 0.080.

The XRD analysis of any cross section of the silicon nitride sintered body according to the embodiment satisfies both Formulas 1 and 2. In other words, the silicon nitride sintered body according to the embodiment satisfies both Formulas 1 and 2 no matter which cross section is analyzed.

The maximum peak intensities detected at 19.1±0.3°, 31.0±0.3°, and 32.5±0.3° are respectively taken as I_{19.1°}, I_{31.0°}, and I_{32.5°}. The peaks detected in these ranges correspond to R₄Al₂O₉ crystals (R being a rare-earth element). It is sufficient for a peak to be present in at least one range among 19.1±0.3°, 31.0±0.3°, and 32.5±0.3°. Peaks that correspond to R₄Al₂O₉ crystals may be present in ranges other than the three ranges of 19.1±0.3°, 31.0±0.3°, and 32.5±0.3°. It is favorable for XRD peaks based on R₄Al₂O₉ crystals and β-Si₃N₄ crystals to satisfy the following Formula 3.

$$0 \leq ( {I}_{19.1 °} + {I}_{31. °} + {I}_{32.5 °} ) / ( {I}_{33.6 °} + {I}_{3 6.1 °} ) \leq 0.100 \qquad Formula 3$$

R of R₄Al₂O₉ represents a rare-earth element. The rare-earth element is at least one selected from the group consisting of yttrium and lanthanoid elements. XRD peaks being detected at 19.1±0.3°, 31.0±0.3°, and 32.5±0.3° indicates that R₄Al₂O₉ is present as a crystal. R₄Al₂O₉ crystals also are referred to as YAM crystals. Herein, “YAM crystal” also includes cases where “R” is an element other than yttrium.

Formula 3 being satisfied indicates that the ratio of the amount of YAM crystals relative to the amount of β-Si₃N₄ crystals is suppressed. If the ratio (I_{19.1°}+I_{31.0°}+I_{32.5°})/(I_{33.6°}+I_{36.1°}) is greater than 0.100, YAM crystals are too plentiful relative to β-Si₃N₄ crystals. In such a case, there is a possibility that it may become difficult to obtain the effects of increased strength, increased wear resistance, etc., caused by the β-Si₃N₄ crystals.

A YAM crystal is a rare-earth aluminum oxide that is formed by a reaction of a rare-earth element component and an aluminum component. Rare-earth element components and aluminum components are added as sintering aids. The rare-earth aluminum oxide is, for example, R₄Al₂O₉ crystals, R₃Al₅O₁₂ crystals, and RAlO₃ crystals. “R” in each is a rare-earth element (yttrium or a lanthanoid element). R₄Al₂O₉ crystals are referred to as YAM crystals. R₃Al₅O₁₂ crystals are referred to as YAG crystals. RAlO₃ crystals are referred to as YAL crystals. YAL crystals also are referred to as YAP crystals. “YAM crystal”, “YAG crystal”, and “YAL crystal” also include cases where “R” is an element other than yttrium.

The melting point of a YAM crystal is higher than the melting point of a YAG crystal and the melting point of a YAL crystal. The melting point of a YAM crystal is 1,950° C.; the melting point of a YAG crystal is 1,908° C.; and the melting point of a YAL crystal is 1,907° C. When the wear-resistant member includes YAM crystals, the durability for frictional heat of the sliding surface can be increased. YAG crystals and YAL crystals tend to cause the formation of white regions, which are described below, more easily than YAM crystals. That is, when rare-earth aluminum oxide crystals are present in the sintered body, it is favorable for the rare-earth aluminum oxide crystals to be present as YAM crystals. It is therefore favorable for the ratio (I_{19.1°}+I_{31.0°}+I_{32.5°})/(I_{33.6°}+I_{36.1°}) to be within the range of not less than 0 and not more than 0.100, and more favorably within the range of not less than 0.001 and not more than 0.090.

It is favorable for XRD peaks based on R₃Al₅O₁₂ crystals (YAG crystals) and XRD peaks based on RAlO₃ crystals (YAL crystals) not to be detected (or to be below the detection limit). Peaks based on YAG crystals and YAL crystals not being detected indicates that R₃Al₅O₁₂ crystals and RAlO₃ crystals are not present in the sintered body, or that these crystals are in trace amounts that cannot be detected by XRD. Therefore, “XRD peaks of YAG crystals and YAL crystals not being detected” includes YAG crystals and YAL crystals being below the detection limit.

By YAG crystals and YAL crystals not being detected, the ratio of rare-earth aluminum oxide crystals present as YAM crystals can be increased. As explained above, the durability for frictional heat of the sliding surface can be increased when the wear-resistant member includes YAM crystals. By increasing the ratio of YAM crystals, the effect of the durability for frictional heat can be further increased.

There are also cases where R₃Al₅O₁₂ and RAlO₃ are present as amorphous phases. In the silicon nitride sintered body according to the embodiment, at least one selected from R₄Al₂O₉, R₃Al₅O₁₂, and RAlO₃ may be present as an amorphous phase. R₃Al₅O₁₂ and RAlO₃ tend to cause the formation of white regions, which are described below, more easily than R₄Al₂O₉. In other words, the R₄Al₂O₉ amorphous phase does not easily become a white region. Therefore, when the silicon nitride sintered body includes an amorphous phase of a rare-earth aluminum oxide, it is favorable for the rare-earth aluminum oxide to be present as a R₄Al₂O₉ amorphous phase. It is favorable for less of the R₃Al₅O₁₂ amorphous phase and the RAlO₃ amorphous phase to be present.

For example, when yttrium is used, peaks based on YAG crystals are detected at 33.3°±0.3°, 55.1°±0.3°, 57.4°±0.3°, etc. Peaks based on YAL crystals are detected at 28.1°±0.3°, 32.9°±0.3°, 49.6°±0.3°, etc. The PDF card is referenced when determining the presence of XRD peaks based on a specific crystal compound. The PDF card also is called the JCPDS card or the ICDD card. If YAM crystals, YAG crystals, and YAL crystals cannot be discriminated based on the XRD peaks, the crystals may be analyzed using TEM, etc.

The maximum peak intensities detected at 36.5±0.3° and 42.4±0.3° are respectively taken as I_{36.5°} and I_{42.4°}. The peaks that are detected in these ranges correspond to titanium nitride. It is sufficient for a peak to be present in at least one range among 36.5±0.3° and 42.4±0.3°. Peaks that correspond to titanium nitride may be present in ranges other than the two ranges of 36.5±0.3° and 42.4±0.3°. It is favorable for the XRD peaks based on titanium nitride and β-Si₃N₄ crystals to satisfy the following Formula 4.

$$0.020 \leq ( {I}_{36.5 °} + {I}_{4 2.4 °} ) / ( {I}_{33.6 °} + {I}_{36.1 °} ) \leq 0.050 \qquad Formula 4$$

In the silicon nitride sintered body according to the embodiment, it is favorable to use both a rare-earth element component and an aluminum component as sintering aids. In addition to these components, at least one component selected from the group consisting of titanium (Ti), hafnium (Hf), molybdenum (Mo), tungsten (W), magnesium (Mg), and zirconium (Zr) also can be used as sintering aids. The additional component selected from the group consisting of Ti, Hf, Mo, W, Mg, and Zr is, for example, at least one compound selected from the group consisting of oxide, nitride, carbide, and silicide. The additional component may be a conjugated compound. The conjugated compound is, for example, an oxynitride. Silicon carbide (SiC) may be added to the sintering aid. Ti, Hf, Mo, W, Mg, Zr, and SiC perform the role of reinforcing the grain boundary phase.

For example, JP 5362758 (Patent Literature 3) discusses a silicon nitride sintered body including titanium nitride grains having an aspect ratio of 1.0 to 1.2. In Patent Literature 3, titanium oxide that is added becomes titanium nitride grains in the sintering process. In other words, titanium changes from an oxide to a nitride in the sintering process. In the process of changing from an oxide to a nitride, small grains of titanium nitride can be dispersed in the sintered body. As a result, the grain boundary phase can be reinforced. Reinforcing the grain boundary phase leads to an improvement of the wear resistance, strength, fracture toughness, etc. It is therefore favorable for the sintered body to include titanium nitride grains. In XRD analysis, I_{36.5°} or I_{42.4°} being detected indicates that titanium nitride (TiN) is present as a crystal.

If the ratio (I_{36.5°}+I_{42.4°})/(I_{33.6°}+I_{36.1°}) is less than 0.020, there is a possibility that the amount of titanium nitride relative to the amount of β-Si₃N₄ crystals may be low, and the effects caused by titanium nitride may be insufficient. If the ratio (I_{36.5°}+I_{42.4°})/(I_{33.6°}+I_{36.1°}) is greater than 0.050, there is a possibility that the amount of titanium nitride relative to the amount of β-Si₃N₄ crystals may be too high. If the amount of titanium nitride is excessively high, there is a possibility that the ratio of melilite crystals in the grain boundary phase may be insufficient.

The grain boundary phase can be further reinforced by the ratio (I_{36.5°}+I_{42.4°})/(I_{33.6°}+I_{36.1°}) being within the range of not less than 0.020 and not more than 0.050 in addition to Formulas 1 and 2 being satisfied. That is, the grain boundary phase can be reinforced while controlling the amount present and orientation of the β-Si₃N₄ crystals, the hexagonal α-SiAION crystals, and the melilite crystals. By satisfying Formula 3 in addition to Formulas 1, 2, and 4, YAM crystals and titanium nitride can coexist in the grain boundary phase. As a result, the grain boundary phase can be further reinforced.

The range of 36.1°±0.3° in which a peak based on β-Si₃N₄ crystals may appear partially overlaps the range of 36.5°±0.3° in which a peak based on titanium nitride may appear. β-Si₃N₄ is the base material of the silicon nitride sintered body. The peak that is based on β-Si₃N₄ is much larger than the peak based on titanium nitride. Therefore, the peak based on β-Si₃N₄ crystals and the peak based on titanium nitride are discriminable. For example, when the silicon nitride sintered body includes titanium nitride but no peaks are confirmed in any of the ranges of 35.8° to 36.2° and 36.4° to 36.8°, multiple peaks may appear in the range of 36.2° to 36.4°. In such a case, a maximum peak appears in the range of 36.2° to 36.3°. The maximum peak is determined to be a peak based on β-Si₃N₄ crystals. The second largest peak appears in the range of 36.3° to 36.4°. The second largest peak is determined to be a peak based on titanium nitride crystals.

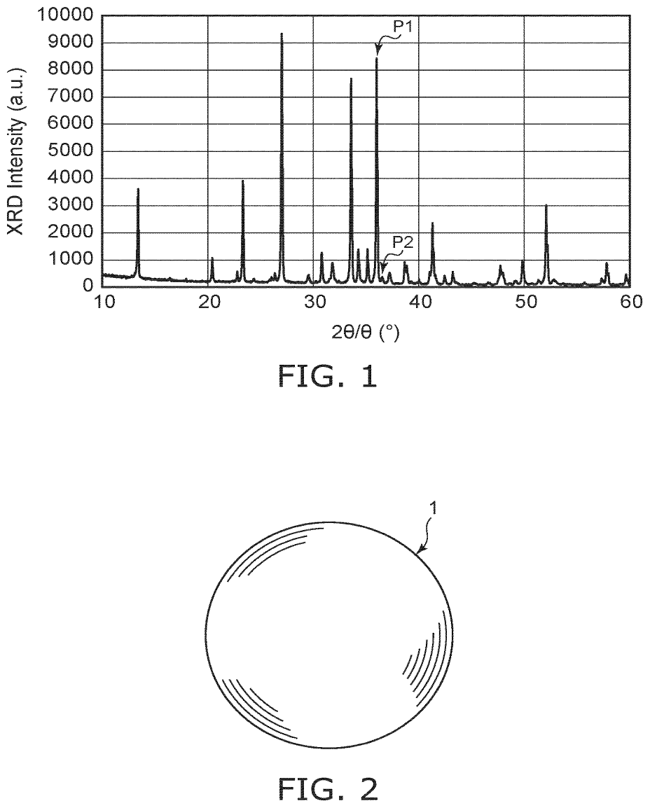

FIG. 1 shows an example of XRD analysis results of the silicon nitride sintered body according to the embodiment. As shown in FIG. 1, a peak P2 at 36.5°±0.3° based on titanium nitride is detected at the vicinity of the base of a peak P1 at 36.1°±0.3° based on β-Si₃N₄ crystals.

It is favorable for the silicon nitride sintered body to include not less than 3 mass % and not more than 7 mass % of Al and not less than 2 mass % and not more than 8 mass % of a rare-earth element. The Al content is the value converted into elemental Al. The content of the rare-earth element is a value converted into elemental rare-earth element. The Al in the silicon nitride sintered body may be present as a compound in which Al is bonded to another component. When multiple rare-earth elements are added, it is favorable for the total amount of rare-earth element to be within the range of not less than 2 mass % and not more than 8 mass %. Al is a constituent element of the hexagonal α-SiAION crystals or the YAM crystals. The rare-earth element is a constituent element of the melilite crystals or the YAM crystals.

It is favorable for the oxygen amount in the silicon nitride sintered body to be within the range of not less than 2.0 mass % and not more than 4.0 mass %. “The oxygen amount in the silicon nitride sintered body” refers to the total oxygen amount included in the silicon nitride sintered body. The formation of the crystals can be controlled by controlling the oxygen amount. It is therefore favorable for the oxygen amount in the silicon nitride sintered body to be within the range of not less than 2.0 mass % and not more than 4.0 mass %, and more favorably within the range of not less than 2.5 mass % and not more than 3.4 mass %.

It is favorable for the iron (Fe) content in the silicon nitride sintered body to be within the range of not less than 10 wtppm and not more than 3,000 wtppm. Iron may be included as an impurity in the silicon nitride powder or the sintering aid powder. Iron may be mixed as an impurity when iron alloys are used in the manufacturing equipment. The iron content in the silicon nitride sintered body is the content converted into elemental iron. The iron in the silicon nitride sintered body also is present as compounds.

It is favorable for the chrome (Cr) content in the silicon nitride sintered body to be within the range of not less than 10 wtppm and not more than 3,000 wtppm. Chrome may be included as an impurity in the silicon nitride powder or the sintering aid powder. Chrome also is mixed as an impurity when stainless steel is used in the manufacturing equipment. The chrome content in the silicon nitride sintered body is the content converted into elemental chrome. The chrome in the silicon nitride sintered body also is present as compounds.

It is favorable for the calcium (Ca) content in the silicon nitride sintered body to be within the range of not less than 10 wtppm and not more than 3,000 wtppm. Calcium may be included as an impurity in the silicon nitride powder or the sintering aid powder. The calcium content in the silicon nitride sintered body is the content converted into elemental calcium. The calcium in the silicon nitride sintered body also is present as compounds.

Fe, Cr, and Ca are mainly impurities in the silicon nitride powder. These impurities cause nonuniformity of the sinterability. If the sinterability is nonuniform, fluctuation of the grain growth, etc., may occur, which may cause degradation of the strength or wear resistance. As explained above, by controlling the XRD peaks of the hexagonal α-SiAION crystals, the β-Si₃N₄ crystals, and the melilite crystals, even when these impurities are included in the sintered body, the characteristics of the sintered body can be improved. In particular, a silicon nitride powder manufactured by direct nitriding includes a high amount of the impurities described above. According to the embodiment, even when a silicon nitride powder manufactured by direct nitriding is used, the characteristics of the sintered body can be improved.

It is favorable for the Fe content of the silicon nitride sintered body to be within the range of not less than 10 wtppm and not more than 3,000 wtppm, and more favorably within the range of not less than 50 wtppm and not more than 2,000 wtppm. It is favorable for the Cr content of the silicon nitride sintered body to be within the range of not less than 10 wtppm and not more than 3,000 wtppm, and more favorably within the range of not less than 50 wtppm and not more than 2,000 wtppm. It is favorable for the Ca content of the silicon nitride sintered body to be within the range of not less than 10 wtppm and not more than 3,000 wtppm, and more favorably within the range of not less than 50 wtppm and not more than 2,000 wtppm. As long as Formulas 1 and 2 are satisfied, a silicon nitride powder that has less impurities may be used to manufacture the silicon nitride sintered body according to the embodiment. For example, a silicon nitride powder manufactured by imide decomposition has a small amount of impurities.

When any cross section of the silicon nitride sintered body is observed with a laser microscope, it is favorable for the area ratio of white regions in a measurement area of 4,000 μm×4,000 μm to be not more than 70%. The cross section that is observed by laser microscope may be the same as the measurement surface of the XRD analysis.

Measurement conditions of the laser microscope will now be described. The laser microscope is the 3D laser scanning microscope VK-X1000 manufactured by Keyence Corporation or an equivalent apparatus. The magnification of the laser microscope is set to 20 times; and a measurement area of 4,000 μm×4,000 μm is observed in dark-field. The area ratio of white regions is calculated by performing image analysis of the dark-field image. In the image analysis, the image is binarized using the image analysis software Image-J.

The binarization method is as follows. A dark-field image (a color image) is taken by setting the “brightness” item of the laser microscope to 120; and the color image is converted to a grayscale image having a gradation of 0 to 255. The binarization threshold is set to 230. The binarization is performed so that regions having a pixel value of not less than 230 are set to white regions; and regions having a pixel value of less than 230 are set to black regions. The ratio of the area of the white regions in the binary image is calculated.

The white regions occur due to structural defects. Structural defects occur due to voids, sintering aid segregation, impurity segregation, density fluctuation, etc. R₃Al₅O₁₂ and RAlO₃ tend to cause the formation of white regions more easily than R₄Al₂O₉. R₃Al₅O₁₂ and RAlO₃ easily cause white regions in both crystalline and amorphous forms. Most favorably, the area ratio of white regions is 0% (or below the detection limit). On the other hand, as explained above, white regions form more easily when a silicon nitride powder having a high amount of impurities is used. By satisfying Formulas 1 and 2 above, the characteristics of the sintered body can be improved even when white regions are present. It is favorable for the area ratio of white regions to be within the range of not less than 0% and not more than 70%, and more favorably within the range of not less than 0% and not more than 30%.

The area ratio of white regions may be 3% or more. If the area ratio of white regions is to be reduced to 0%, this may place a high burden on production control. By controlling the XRD peak ratios of Formulas 1 and 2 above, the wear resistance of the sintered body can be improved even when the area ratio of white regions is within the range of not less than 3% and not more than 70% or within the range of not less than 3% and not more than 30%.

When any cross section of the silicon nitride sintered body is observed with SEM, it is favorable for multiple crystal grains in a measurement area of 20 μm×15 μm to have a major diameter of not less than 2.5 μm and an aspect ratio of not less than 2.5. It is also favorable for the total area ratio of the crystal grains to be within the range of not less than 20% and not more than 70%. The cross section observed with SEM may be the same as the observation surface of the laser microscope or the measurement surface of the XRD analysis.

The SEM observation method will now be described. SEM is performed using the JCM-7000 manufactured by JOEL, the JSM-7200F manufactured by JOEL, or an equivalent or better apparatus. The magnification is set to 5,000 times. A measurement area of 20 μm×15 μm is observed, and a SEM image is obtained. Crystal grains that have a major diameter of not less than 2.5 μm and an aspect ratio of not less than 2.5 are extracted from the SEM image. The crystal grains appear darker than the grain boundaries and appear to be, for example, gray. Therefore, the crystal grains are discriminable from the grain boundaries.

The “major diameter” is the distance between the two most distant points positioned on the boundary of the crystal grain. The “minor diameter” is the dimension of the crystal grain in a direction passing through the midpoint of the major diameter perpendicular to the direction of the major diameter. The aspect ratio is calculated as major diameter divided by minor diameter. The crystal grains that have a major diameter of not less than 2.5 μm and an aspect ratio of not less than 2.5 are extracted from a measurement area of 20 μm×15 μm; and the total area of the crystal grains is calculated. The total area ratio is calculated by dividing the total area by the area of the entire SEM image. Three non-overlapping 20 μm×15 μm areas are observed, and the total area ratio is calculated for each measurement area. The average of the three total area ratios is used as the final total area ratio. Even when the contour of a crystal grain is partially cut off in the measurement area, the crystal grain is included in the count if the crystal grain has a major diameter of not less than 2.5 μm and an aspect ratio of not less than 2.5. Herein, a crystal grain that has a major diameter of not less than 2.5 μm and an aspect ratio of not less than 2.5 is referred to as a “major-axis crystal grain”.

The major-axis crystal grains are mainly β-Si₃N₄ crystal grains. The presence of multiple major-axis crystal grains in a measurement area of 20 μm×15 μm substantially indicates that multiple β-Si₃N₄ crystal grains are present. Additionally, it is favorable for the total area ratio of the major-axis crystal grains to be within the range of not less than 20% and not more than 70%. According to the embodiment, the orientation of the β-Si₃N₄ crystal grains in a narrow region of 20 μm×15 μm is controlled. The wear resistance of the sintered body can be further improved thereby.

The major-axis crystal grains become complexly entangled, and crystal grains having an aspect ratio of less than 2.5 become positioned between the major-axis crystal grains, thereby improving the characteristics of the sintered body. Crystal grains other than β-Si₃N₄ crystal grains in the cross-section observation may be counted as major-axis crystal grains. When Formulas 1 and 2 above are satisfied, many of the major-axis crystal grains are β-Si₃N₄ crystal grains.

According to the silicon nitride sintered body having the features described above, the Vickers hardness HV can be 1,500 or more. The fracture toughness value can be 6.0 MPa·m^{1/2} or more. The Vickers hardness (Hv) is measured by a method in accordance with JIS-R-1610 with a pressing load 20 kgf. The fracture toughness value is measured in accordance with the indentation fracture method (the IF method) of JIS-R-1607 with a pressing load 20 kgf, and is calculated using Niihara's equation. JIS-R-1610 corresponds to ISO 14705. JIS-R-1607 corresponds to ISO 15732.

According to the embodiment, the fluctuation of the Vickers hardness can be suppressed. The fluctuation of the fracture toughness value can be suppressed. When the Vickers hardness HV of any one hundred silicon nitride sintered bodies is measured, the difference between the maximum value of the Vickers hardness HV and the minimum value of the Vickers hardness HV can be 80 or less. When the fracture toughness value of any one hundred silicon nitride sintered bodies is measured, the difference between the maximum value of the fracture toughness value and the minimum value of the fracture toughness value can be 0.8 MPa·m^{1/2} or less.

The silicon nitride sintered body according to the embodiment can be used in a wear-resistant member. The wear-resistant member is, for example, a bearing ball, a roller, a check ball, a wear pad, a plunger, a roller, a friction stir welding tool member, etc. Such a wear-resistant member slides against a mating member made of a metal member, a ceramic, etc. To increase the durability of the sliding surface, it is favorable for the surface roughness (Ra) of the wear-resistant member to be not more than 0.5 μm, more favorably not more than 0.1 μm, and most favorably not more than 0.05 μm. The surface roughness (Ra) of the sliding surface can be reduced by using a polished surface as the sliding surface.

According to the embodiment, the fluctuation of the hardness of the silicon nitride sintered body is suppressed. Therefore, the fluctuation of the polishing efficiency also is suppressed, and so similar polished surfaces can be obtained using the same polishing time.

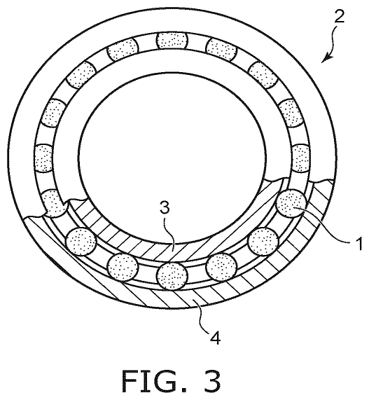

A bearing ball will now be described as an example of a wear-resistant member. FIG. 2 shows an example of a bearing ball. FIG. 3 shows an example of a bearing. FIGS. 2 and 3 show a bearing ball 1. FIG. 3 shows a bearing 2, an inner ring 3, and an outer ring 4.

The bearing ball 1 is a member made of the silicon nitride sintered body according to the embodiment. Multiple bearing balls 1 are located between the inner ring 3 and the outer ring 4 in the bearing 2. In the example shown in FIG. 3, sixteen bearing balls 1 are used in the bearing 2.

Toshiba Review, Vol. 60, No. 11, (2005), p. 41-44 (Non-Patent Literature 1) discusses a motor of an electric vehicle (EV) or a hybrid electric vehicle (HEV). The maximum rotational speed of the passenger car motor is said to reach 10,000 to 15,000 rpm. An electric vehicle repeatedly runs and stops, and so the rotational speed of the motor changes within the range of 0 to 15,000 rpm. An inverter motor has been developed to correspond to the change of the rotational speed of the motor. In the inverter motor, the rotational speed of the motor is controlled by controlling the frequency of the power supplied to an AC (alternating current) motor. As described in Non-Patent Literature 1, changes in the rotational speed lead to changes in torque. In mechanics, torque is the moment of a force around a fixed rotation axis that acts with the rotation axis at the center. In other words, an environment in which the rotational speed changes is an environment in which the torque (i.e., the stress) applied to the bearing ball changes.

According to the embodiment, the silicon nitride sintered body suppresses the fluctuation of the fracture toughness value. The fracture toughness value is a metric that indicates the resistance to damage. Specifically, the fracture toughness value indicates the resistance to damage when a dynamic load is applied to a member having a crack or a crack-shaped defect. The fracture toughness value is one type of specific metric representing the toughness. The toughness means the resistance to damage of the material.

For the bearing 2, the torque changes as the rotational speed changes. The stress that is applied to the bearing ball 1 changes as the torque changes. In other words, when the rotational speed changes, the stress that is applied to the bearing ball 1 changes as the bearing ball 1 slides. Eccentricity occurs particularly when the rotational speed is high. Eccentricity slightly changes the gap between the bearing ball and the inner and outer rings. The change of the gap leads to a change of the contact state between the bearing ball 1 and the inner ring 3 and between the bearing ball 1 and the outer ring 4; and the bearing ball 1 applies a large load on the inner ring 3 and the outer ring 4. As a result, degradation of the wear resistance and electrolytic corrosion may occur.

According to the embodiment, the fluctuation of the fracture toughness value of the silicon nitride sintered body is suppressed. By suppressing the fluctuation of the fracture toughness value, the load of the bearing ball 1 on the inner ring 3 and the outer ring 4 is stable even in an environment in which eccentricity may occur. Therefore, the durability of the bearing 2 can be improved. According to the embodiment, not only the durability of the bearing ball 1 but also the durability of the bearing 2 can be improved. In other words, the wear-resistant member according to the embodiment is favorable as a bearing ball used in an inverter motor bearing.

A method for manufacturing a silicon nitride sintered body according to an embodiment will now be described. The manufacturing method is not limited as long as the silicon nitride sintered body according to the embodiment has the features described above. A method for obtaining a silicon nitride sintered body with a high yield will now be described.

First, a silicon nitride powder is prepared. It is favorable for the silicon nitride powder to include not less than 85 mass % of α-phase silicon nitride (α-Si₃N₄), and for the average grain size to be not more than 2 μm. It is favorable for the oxygen content of the silicon nitride powder to be not more than 2 mass %.

A silicon nitride powder that has an impurity Fe content within the range of not less than 10 wtppm and not more than 3,000 wtppm may be used. A silicon nitride powder that has an impurity Cr content within the range of not less than 10 wtppm and not more than 3,000 wtppm may be used. A silicon nitride powder that has an impurity Ca content within the range of not less than 10 wtppm and not more than 3,000 wtppm may be used. For example, impurities within the ranges described above may be included in a silicon nitride powder manufactured by direct nitriding. Or, a silicon nitride powder that includes fewer impurities than the ranges described above may be used in the method for manufacturing the silicon nitride sintered body according to the embodiment. For example, a silicon nitride powder manufactured by imide decomposition includes fewer impurities than the ranges described above. The silicon nitride sintered body according to the embodiment can be manufactured even when a silicon nitride powder including more impurities than the ranges described above is used.

Then, a sintering aid powder is prepared. The sintering aid powder is, for example, a rare-earth element compound and an aluminum compound. The rare-earth element compound is, for example, at least one selected from the group consisting of an oxide of yttrium, an oxynitride of yttrium, an oxide of a lanthanoid element, and an oxynitride of a lanthanoid element. By using a rare-earth element oxide or a rare-earth element oxynitride, it becomes easier to form hexagonal α-SiAION crystals and R₂Si₃O₃N₄ crystals. When the total of the silicon nitride powder and all of the sintering aid powders is taken to be 100 mass %, it is favorable for the added amount of the rare-earth element compound in terms of the elemental rare-earth element to be within the range of not less than 2 mass % and not more than 8 mass %.

The aluminum compound is, for example, at least one selected from the group consisting of aluminum oxide, aluminum nitride, and aluminum oxynitride. When both aluminum nitride and aluminum oxide are used, it is favorable for the ratio of the added amount (the mass) of aluminum nitride relative to the total amount of the added amounts of aluminum nitride and aluminum oxide to be within the range of not less than 0.6 and not more than 0.95. In other words, it is favorable for 0.6≤aluminum nitride added amount (mass %)/(aluminum nitride added amount (mass %)+aluminum oxide added amount (mass %))≤0.95. Aluminum nitride is represented by AlN; and aluminum oxide is represented by Al₂O₃. By controlling the mass ratio of the added AlN and Al₂O₃ (AlN/(AlN+Al₂O₃)), it becomes easier to form hexagonal α-SiAION crystals and R₄Al₂O₉ crystals. The formation of R₃Al₅O₁₂ crystals and RAlO₃ crystals also can be suppressed. It is therefore favorable for the mass ratio (AlN/(AlN+Al₂O₃)) to be within the range of not less than 0.6 and not more than 0.95, and more favorably within the range of not less than 0.75 and not more than 0.85. When the total of the silicon nitride powder and all of the sintering aid powders is taken to be 100 mass %, it is favorable for the added amount of the aluminum compound in terms of elemental aluminum to be within the range of not less than 3 mass % and not more than 7 mass %.

In addition to the rare-earth element compound and the aluminum compound, at least one component selected from the group consisting of titanium (Ti), hafnium (Hf), molybdenum (Mo), tungsten (W), magnesium (Mg), and zirconium (Zr) may be added as a sintering aid as necessary. The component selected from the group consisting of titanium (Ti), hafnium (Hf), molybdenum (Mo), tungsten (W), magnesium (Mg), and zirconium (Zr) is, for example, at least one compound selected from the group consisting of an oxide, a nitride, a carbide, and a silicide. When the total of the silicon nitride powder and all of the sintering aid powders is taken to be 100 mass %, it is favorable for the total of the added amounts of the sintering aids other than the rare-earth element compound and the aluminum compound to be within the range of not less than 0.1 mass % and not more than 10 mass %, and more favorably within the range of not less than 0.2 mass % and not more than 5 mass %. Silicon carbide (SiC) or silicon oxide (SiO₂) may be added to the sintering aid as necessary. It is favorable for the added amount of silicon carbide or silicon oxide to be within the range of not less than 0.1 mass % and not more than 10 mass %. The added amount of silicon carbide or silicon oxide is the value when the total of the silicon nitride powder and all of the sintering aid powders (including silicon carbide or silicon oxide) is taken to be 100 mass %.

When the total of the silicon nitride powder and all of the sintering aid powders is taken to be 100 mass %, it is favorable for the oxygen amount to be within the range of not less than 2.0 mass % and not more than 4.0 mass %. The “oxygen amount” represents the oxygen content in the raw material powder and is, for example, the total value of the oxygen amount of the silicon nitride powder, the oxygen amount of the rare-earth oxide powder, the oxygen amount of the aluminum oxide powder, etc. Control of the oxygen amount in the raw material powder leads to control of the oxygen amount in the silicon nitride sintered body. As a result, the formation of the crystals can be controlled. It is therefore favorable for the oxygen amount in the raw material powder to be within the range of not less than 2.0 mass % and not more than 4.0 mass %, and more favorably within the range of not less than 2.5 mass % and not more than 3.4 mass %.

It becomes easier to better control the formation of the crystals by combining the control of the oxygen amount and the control of the mass ratio AlN/(AlN+Al₂O₃). Thus, when manufacturing the silicon nitride sintered body according to the embodiment, it is favorable to form the crystals by mixing at least the three types of powders of the silicon nitride powder, the rare-earth element compound powder, and the aluminum compound powder and by reacting the components. The crystals can be more uniformly distributed than when a hexagonal α-SiAION powder or a R₂Si₃O₃N₄ powder is used as the raw material powder.

Then, a pulverizing process is performed in which the silicon nitride powder and the sintering aid powder are mixed. A ball mill or other pulverizer is used in the pulverizing process. A binder and a solvent are added to the pulverized mixed powder as necessary.

Then, a forming process is performed. The forming process is, for example, die molding, cold isostatic pressing (CIP), injection molding, tumbling granulation, sheet forming, etc. Die molding or tumbling granulation is used when making a spherical silicon nitride sintered body. When making a silicon nitride sintered body used in a bearing ball, the compact that is obtained by die molding may be subjected to cold isostatic pressing (CIP). A compact is obtained by performing the forming process.

A dewaxing process is performed on the compact thus obtained. The binder and the like are removed in the dewaxing process. It is favorable for the dewaxing process to be performed at a temperature within the range of 300 to 600° C. The atmosphere of the dewaxing process is not particularly limited, and may be ambient air or a nonoxidizing atmosphere. The nonoxidizing atmosphere is, for example, a nitrogen atmosphere or an argon atmosphere. A dewaxed body is obtained by the dewaxing process.

A sintering process of sintering the dewaxed body is performed. It is favorable for the sintering temperature to be within the range of not less than 1,700° C. and not more than 1,900° C. If the sintering temperature is less than 1,700° C., there is a possibility that the reaction of the components may be insufficient, and the formation of the crystals may be insufficient. If the sintering temperature is greater than 1,900° C., there is a possibility that the grain growth of the β-Si₃N₄ crystal grains may be excessive. It is therefore favorable for the sintering temperature to be within the range of not less than 1,700° C. and not more than 1,900° C., and more favorably within the range of not less than 1,775° C. and not more than 1,825° C.

Either pressureless sintering or pressure sintering may be performed in the sintering process. It is favorable to perform the sintering process in a nonoxidizing atmosphere. The nonoxidizing atmosphere is, for example, a nitrogen atmosphere or an argon atmosphere.

It is favorable to perform hot isostatic pressing (HIP) at not less than 30 MPa in a nonoxidizing atmosphere after the sintering process as necessary. The nonoxidizing atmosphere is, for example, a nitrogen atmosphere or an argon atmosphere. It is favorable for the temperature of the HIP processing to be within the range of not less than 1,500° C. and not more than 1,900° C. By performing HIP processing, pores inside the silicon nitride sintered body can be reduced (e.g., eliminated). If the pressure of the HIP processing is less than 30 MPa, such effects cannot be sufficiently obtained. It is therefore favorable for the pressure to be not less than 30 MPa. The upper limit of the pressure of the HIP processing is not particularly limited, and is favorably not more than 200 MPa. If the pressure is greater than 200 MPa, there is a possibility that the load on the apparatus may increase.

By performing HIP processing, the value of the ratio (I_{19.1°}+I_{31.0°}+I_{32.5°})/(I_{33.6°}+I_{36.1°}) can be reduced. That is, XRD peaks based on YAM crystals can be reduced. Similarly, XRD peaks based on YAG crystals and XRD peaks based on YAL crystals also can be reduced. Therefore, another effect of HIP processing is that XRD peaks based on YAG crystals and XRD peaks based on YAL crystals are not detected. It is considered that this is because HIP processing causes some or all of YAM, YAG, and YAL to be incorporated into the hexagonal α-SiAION crystals.

For example, when a titanium oxide powder is added, the titanium oxide powder reacts with the silicon nitride powder in the sintering process to form titanium nitride grains. By performing HIP processing on the silicon nitride sintered body including titanium nitride, it becomes easier to control the ratio (I_{36.5°}+I_{42.4°})/(I_{33.6°}+I_{36.1°}) to be within the range of not less than 0.020 and not more than 0.050. It is considered that the HIP processing improves the crystallinity of the titanium nitride grains.

The wear-resistant member is obtained by polishing the silicon nitride sintered body thus manufactured at the necessary location. It is favorable to perform the polishing with a diamond abrasive. A polished surface having a surface roughness (Ra) of not more than 0.5 μm can be obtained by polishing. By regulating the size of the abrasive grain, a polished surface having a surface roughness (Ra) of not more than 0.1 μm, or even not more than 0.05 μm can be obtained.

### EXAMPLES

### Examples 1 to 23 and Comparative Examples 1 to 3

A silicon nitride powder was prepared in which the oxygen content was not more than 2 mass %; and not less than 85 mass % of α-phase silicon nitride (α-Si₃N₄) was included. The average particle size of the silicon nitride powder was not more than 2 μm. In each Example and Comparative Example, a silicon nitride powder manufactured by direct nitriding was used. In Examples 1 to 13, Examples 17 to 23, and Comparative Examples 1 to 3, the Fe amount, the Cr amount, and the Ca amount of the silicon nitride powder each were within the range of not less than 50 wtppm and not more than 1,000 wtppm. In Examples 14 to 16, the Fe amount, the Cr amount, and the Ca amount of the silicon nitride powder each were greater than 1,000 wtppm. Then, the sintering aids shown in Table 1 were prepared. In each Example, when the total of the silicon nitride powder and all of the sintering aid powders was taken to be 100 mass %, the added amount of the rare-earth element compound in terms of the elemental rare-earth element was within the range of not less than 2 mass % and not more than 8 mass %; and the Al content in terms of elemental Al was not less than 3 mass % and not more than 7 mass %.

TABLE 1

| | | | | | | | | Oxygen |
|---|---|---|---|---|---|---|---|---|
| | Raw material powder mixing ratio (mass %) | | | | | | AlN/ | amount |
| | Si₃N₄ | Y₂O₃ | Al₂O₃ | AlN | TiO₂ | SiO₂ | (AlN + Al₂O₃) | (mass %) |
| Example1 | 88.6 | 4.4 | 1.2 | 4.5 | 1.3 | — | 0.78 | 2.8 |
| Example2 | 88.6 | 4.4 | 1.2 | 4.5 | 1.3 | — | 0.78 | 2.9 |
| Example3 | 88.6 | 4.4 | 1.2 | 4.5 | 1.3 | — | 0.78 | 2.8 |
| Example4 | 88.7 | 4.4 | 0.5 | 5.1 | 1.3 | — | 0.9 | 2.4 |
| Example5 | 88.7 | 4.4 | 0.5 | 5.1 | 1.3 | — | 0.9 | 2.4 |
| Example6 | 88.7 | 4.4 | 0.5 | 5.1 | 1.3 | — | 0.9 | 2.4 |
| Example7 | 88.7 | 4.4 | 0.5 | 5.1 | 1.3 | — | 0.9 | 2.6 |
| Example8 | 88.7 | 4.4 | 0.5 | 5.1 | 1.3 | — | 0.9 | 2.6 |
| Example9 | 88.7 | 4.4 | 0.5 | 5.1 | 1.3 | — | 0.9 | 2.6 |
| Example10 | 88.2 | 4.4 | 1.2 | 4.5 | 1.3 | 0.4 | 0.78 | 3.1 |
| Example11 | 88.7 | 4.4 | 0.5 | 5.1 | 1.3 | — | 0.9 | 2.4 |
| Example12 | 88.7 | 4.4 | 0.5 | 5.1 | 1.3 | — | 0.9 | 2.4 |
| Example13 | 88.7 | 4.4 | 0.5 | 5.1 | 1.3 | — | 0.9 | 2.4 |
| Example14 | 88.7 | 4.4 | 0.5 | 5.1 | 1.3 | — | 0.9 | 2.6 |
| Example15 | 88.7 | 4.4 | 0.5 | 5.1 | 1.3 | — | 0.9 | 2.6 |
| Example16 | 88.6 | 4.4 | 1.2 | 4.5 | 1.3 | — | 0.78 | 3.1 |
| Example17 | 90.3 | 2.7 | 0.5 | 5.1 | 1.4 | — | 0.9 | 2.4 |
| Example18 | 86.4 | 6.9 | 0.5 | 4.9 | 1.3 | — | 0.9 | 2.9 |
| Example19 | 87.0 | 6.1 (Er₂O₃) | 1.2 | 4.4 | 1.3 | — | 0.78 | 2.7 |
| Example20 | 89.0 | 4.5 | 0.5 | 5.1 | 0.9 | — | 0.9 | 2.6 |
| Example21 | 87.5 | 4.4 | 0.5 | 5.0 | 2.6 | — | 0.9 | 2.9 |
| Example22 | 88.6 | 2.7 | 3.5 | 4.9 | 0.3 | — | 0.71 | 3.1 |
| Example23 | 87.2 | 2.6 | 0.9 | 4.9 | 4.4 | — | 0.65 | 3.4 |
| Comparative | 87.8 | 4.4 | 5.3 | 1.2 | 1.3 | — | 0.19 | 5 |
| Example1 | | | | | | | | |
| Comparative | 87.7 | 4.4 | 3.5 | 3.1 | 1.3 | — | 0.47 | 4.5 |
| Example2 | | | | | | | | |
| Comparative | 88.1 | 4.4 | 4.4 | 1.8 | 1.3 | — | 0.29 | 4.9 |
| Example3 | | | | | | | | |

The raw material powder was pulverized with a ball mill, and then a binder was added. Subsequently, die molding and CIP processing were performed to make a spherical compact including a band-shaped portion. The band-shaped portion was present at the outer circumference of the spherical compact and protruded outward. A dewaxed body was obtained by performing a dewaxing process on the spherical compact having the band-shaped portion. A sintering process and a HIP process were performed on the dewaxed body. In the sintering process, pressure sintering was performed in a nitrogen atmosphere. The temperatures and pressures of the sintering process and the temperatures and pressures of the HIP process were as shown in Table 2.

TABLE 2

| | Sintering process | | HIP process | |
|---|---|---|---|---|
| | Temperature | Pressure | Temperature | Pressure |
| | (° C.) | (MPa) | (° C.) | (MPa) |
| Example1 | 1800 | 0.5 | 1700 | 110 |
| Example2 | 1825 | 0.7 | 1750 | 100 |
| Example3 | 1825 | 1 | 1775 | 80 |
| Example4 | 1775 | 0.8 | 1800 | 90 |
| Example5 | 1800 | 0.7 | 1720 | 100 |
| Example6 | 1825 | 0.9 | 1775 | 120 |
| Example7 | 1775 | 0.7 | 1775 | 110 |
| Example8 | 1750 | 1 | 1740 | 100 |
| Example9 | 1725 | 0.7 | 1720 | 100 |
| Example10 | 1775 | 0.7 | 1775 | 80 |
| Example11 | 1800 | 0.6 | 1700 | 105 |
| Example12 | 1800 | 0.5 | 1715 | 105 |
| Example13 | 1800 | 0.8 | 1710 | 105 |
| Example14 | 1765 | 0.7 | 1740 | 100 |
| Example15 | 1775 | 0.7 | 1720 | 100 |
| Example16 | 1785 | 0.7 | 1720 | 80 |
| Example17 | 1770 | 1 | 1760 | 100 |
| Example18 | 1765 | 0.8 | 1750 | 100 |
| Example19 | 1780 | 0.7 | 1720 | 90 |
| Example20 | 1785 | 0.7 | 1775 | 100 |
| Example21 | 1785 | 0.7 | 1775 | 100 |
| Example22 | 1825 | 0.7 | 1750 | 100 |
| Example23 | 1810 | 0.7 | 1750 | 100 |
| Comparative | 1775 | 0.7 | 1800 | 80 |
| Example1 | | | | |
| Comparative | 1775 | 0.7 | 1775 | 100 |
| Example2 | | | | |
| Comparative | 1750 | 0.7 | 1725 | 100 |
| Example3 | | | | |

The silicon nitride sintered bodies according to the Examples and the Comparative Examples were manufactured by the processes described above. XRD analysis was performed on arbitrary cross sections of the silicon nitride sintered bodies. The peaks based on each crystal were identified in the XRD analysis results; and each maximum peak intensity was recorded. The maximum peak intensity ratios specified in Formulas 1 to 4 were calculated using the maximum peak intensities. The presence of peaks based on YAG crystals and peaks based on YAL crystals also were checked. The conditions of the XRD analysis were as described above. The results are shown in Table 3.

TABLE 3

| | XRD analysis | | | | |
|---|---|---|---|---|---|
| | | | | | YAG or |
| | | | | | YAL |
| | | | | | crystal |
| | Formula 1 | Formula 2 | Formula 3 | Formula 4 | peak |
| Example1 | 0.111 | 0.076 | 0.048 | 0.036 | No |
| Example2 | 0.117 | 0.048 | 0.047 | 0.032 | No |
| Example3 | 0.117 | 0.063 | 0.056 | 0.032 | No |
| Example4 | 0.204 | 0.064 | 0.08 | 0.036 | No |
| Example5 | 0.211 | 0.057 | 0.088 | 0.034 | No |
| Example6 | 0.194 | 0.047 | 0.081 | 0.036 | No |
| Example7 | 0.175 | 0.052 | 0.071 | 0.034 | No |
| Example8 | 0.165 | 0.082 | 0.066 | 0.036 | No |
| Example9 | 0.164 | 0.07 | 0.069 | 0.036 | No |
| Example10 | 0.06 | 0.056 | 0.021 | 0.031 | No |
| Example11 | 0.154 | 0.057 | 0.042 | 0.033 | No |
| Example12 | 0.141 | 0.056 | 0.056 | 0.033 | No |
| Example13 | 0.138 | 0.052 | 0.074 | 0.034 | No |
| Example14 | 0.154 | 0.057 | 0.042 | 0.033 | No |
| Example15 | 0.141 | 0.046 | 0.043 | 0.033 | No |
| Example16 | 0.138 | 0.066 | 0.041 | 0.034 | No |
| Example17 | 0.152 | 0.049 | 0.082 | 0.036 | No |
| Example18 | 0.202 | 0.077 | 0.081 | 0.036 | No |
| Example19 | 0.198 | 0.067 | 0.070 | 0.031 | No |
| Example20 | 0.163 | 0.081 | 0.061 | 0.022 | No |
| Example21 | 0.167 | 0.071 | 0.068 | 0.072 | No |
| Example22 | 0.144 | 0.067 | 0.052 | 0.011 | No |
| Example23 | 0.131 | 0.036 | 0.051 | 0.124 | No |
| Comparative | 0 | 0.017 | 0.014 | 0.03 | Yes |
| Example1 | | | | | |
| Comparative | 0.059 | 0.118 | 0.015 | 0.032 | Yes |
| Example2 | | | | | |
| Comparative | 0.067 | 0 | 0 | 0.033 | Yes |
| Example3 | | | | | |

In Table 3, “Formula 1” represents the maximum peak intensity ratio (I_{20.5°}+I_{22.8°}+I_{34.3°}+I_{38.7°})/(I_{33.6°}+I_{36.1°}). “Formula 2” represents the maximum peak intensity ratio (I_{31.8°}+I_{37.2°})/(I_{33.6°}+I_{36.1°}). Formula 3 represents the maximum peak intensity ratio (I_{19.1°}+I_{31.0°}+I_{32.5°})/(I_{33.6°}+I_{36.1°}). Formula 4 represents the maximum peak intensity ratio (I_{36.5°}+I_{42.4°})/(I_{33.6°}+I_{36.1°}).

The silicon nitride sintered bodies according to each of the Examples satisfied Formulas 1 to 4. No XRD peaks of YAG crystals or XRD peaks of YAL crystals were detected in any of the Examples. No XRD peaks based on cubic α-SiAION crystals were detected in any of the Examples. In contrast, each of the silicon nitride sintered bodies according to the Comparative Examples did not satisfy one of Formula 1 or Formula 2.

Then, the Fe amount, the Cr amount, and the Ca amount in the silicon nitride sintered body were measured. An arbitrary cross section of the silicon nitride sintered body was observed with a laser microscope. The total area ratio of white regions was measured in the laser microscope observation results. An arbitrary cross section of the silicon nitride sintered body was observed with SEM. The total area ratio of major-axis crystal grains having a major diameter of not less than 2.5 μm and an aspect ratio of not less than 2.5 was calculated based on the SEM observation results. The measurement methods were as described above. The results are shown in Table 4.

TABLE 4

| | | | | | Total area |
|---|---|---|---|---|---|
| | | | | | ratio of |
| | Impurity (wtppm) | | | Total area ratio | major-axis |
| | Fe | Cr | Ca | of white regions | crystal |
| | amount | amount | amount | (%) | grains(%) |
| Example1 | 38 | 13 | 389 | 0 | 45 |
| Example2 | 102 | 18 | 1011 | 0 | 38 |
| Example3 | 121 | 29 | 823 | 0 | 27 |
| Example4 | 228 | 41 | 448 | 4 | 33 |
| Example5 | 379 | 16 | 107 | 25 | 49 |
| Example6 | 88 | 28 | 566 | 14 | 39 |
| Example7 | 417 | 51 | 702 | 12 | 61 |
| Example8 | 185 | 32 | 481 | 18 | 29 |
| Example9 | 301 | 82 | 612 | 37 | 37 |
| Example10 | 734 | 104 | 932 | 63 | 26 |
| Example11 | 2497 | 32 | 481 | 12 | 28 |
| Example12 | 301 | 2163 | 612 | 15 | 34 |
| Example13 | 734 | 104 | 2768 | 19 | 21 |
| Example14 | 3591 | 32 | 481 | 83 | 79 |
| Example15 | 301 | 8014 | 612 | 88 | 80 |
| Example16 | 734 | 104 | 9425 | 80 | 82 |
| Example17 | 160 | 12 | 529 | 21 | 50 |
| Example18 | 271 | 49 | 318 | 29 | 44 |
| Example19 | 358 | 37 | 498 | 27 | 46 |
| Example20 | 182 | 35 | 475 | 12 | 50 |
| Example21 | 174 | 50 | 587 | 13 | 48 |
| Example22 | 278 | 33 | 689 | 34 | 66 |
| Example23 | 590 | 67 | 312 | 28 | 68 |
| Comparative | 310 | 36 | 884 | 82 | 77 |
| Example1 | | | | | |
| Comparative | 389 | 30 | 731 | 87 | 78 |
| Example2 | | | | | |
| Comparative | 402 | 38 | 931 | 78 | 72 |
| Example3 | | | | | |

The silicon nitride sintered bodies according to the Examples included Fe, Cr, and Ca as impurities. In Examples 1 to 13 and 17 to 23, the total area ratio of the white regions was within the range of not less than 0% and not more than 70%. Multiple major-axis crystal grains were present, and the total area ratio was within the range of not less than 20% and not more than 70%. A YAG amorphous phase and a YAL amorphous phase were not detected in Examples 1 to 3 which had 0% white regions.

The silicon nitride sintered bodies according to the Comparative Examples had contents of Fe, Cr, and Ca equal to those of the silicon nitride sintered bodies according to the Examples. On the other hand, in the Comparative Examples, the total area ratio of the white regions and the total area ratio of the major-axis crystal grains each were outside the respective favorable ranges.

Then, the Vickers hardness HV and the fracture toughness value of the silicon nitride sintered body were measured. The measurement methods of the Vickers hardness HV and the fracture toughness value were as described above. One hundred silicon nitride sintered bodies were prepared for the Examples and the Comparative Examples. The average value, the minimum value, and the maximum value were determined. The results are shown in Table 5.

TABLE 5

| | Vickers hardness HV | | | Fracture toughness value (MPa · m^{1/2}) | | |
|---|---|---|---|---|---|---|
| | Average | Minimum | Maximum | Average | Minimum | Maximum |
| | value | value | value | value | value | value |
| Example1 | 1702 | 1689 | 1722 | 6.1 | 6 | 6.3 |
| Example2 | 1624 | 1600 | 1654 | 6.9 | 6.7 | 7.2 |
| Example3 | 1621 | 1589 | 1642 | 6.1 | 6 | 6.2 |
| Example4 | 1727 | 1702 | 1748 | 7.2 | 7 | 7.5 |
| Example5 | 1748 | 1731 | 1766 | 7.6 | 7.3 | 7.8 |
| Example6 | 1696 | 1669 | 1710 | 7.5 | 7.2 | 7.7 |
| Example7 | 1666 | 1647 | 1716 | 7.6 | 7.4 | 7.8 |
| Example8 | 1725 | 1711 | 1738 | 7.2 | 7 | 7.5 |
| Example9 | 1750 | 1727 | 1781 | 7.2 | 6.9 | 7.4 |
| Example10 | 1652 | 1627 | 1682 | 6.2 | 6 | 6.4 |
| Example11 | 1623 | 1611 | 1652 | 6.5 | 6.4 | 6.8 |
| Example12 | 1684 | 1613 | 1701 | 6.4 | 6.3 | 6.7 |
| Example13 | 1667 | 1621 | 1694 | 6.5 | 6.4 | 6.8 |
| Example14 | 1511 | 1485 | 1621 | 5.7 | 4.9 | 6.1 |
| Example15 | 1503 | 1472 | 1630 | 5.5 | 5.1 | 5.8 |
| Example16 | 1523 | 1465 | 1604 | 5.3 | 4.2 | 5.6 |
| Example17 | 1725 | 1711 | 1738 | 7.3 | 7.2 | 7.5 |
| Example18 | 1750 | 1727 | 1781 | 7.4 | 6.8 | 7.8 |
| Example19 | 1652 | 1627 | 1682 | 7.1 | 6.7 | 7.3 |
| Example20 | 1727 | 1709 | 1740 | 7.1 | 7.0 | 7.5 |
| Example21 | 1748 | 1727 | 1781 | 7.4 | 7.1 | 7.4 |
| Example22 | 1751 | 1734 | 1777 | 7.3 | 7.1 | 7.5 |
| Example23 | 1712 | 1692 | 1737 | 7.3 | 7.1 | 7.5 |
| Comparative | 1542 | 1428 | 1591 | 6.7 | 5.9 | 7 |
| Example1 | | | | | | |
| Comparative | 1524 | 1411 | 1562 | 6.9 | 6 | 7.3 |
| Example2 | | | | | | |
| Comparative | 1552 | 1437 | 1593 | 5.2 | 4 | 5.8 |
| Example3 | | | | | | |

The average Vickers hardness HV of the silicon nitride sintered body was not less than 1,500 for the Examples. The fluctuation was within the range of ±50. The fracture toughness value was not less than 6.0 MPa·m^{1/2}, and the fluctuation was within the range of ±0.8 MPa·m^{1/2}.

In contrast, in the Comparative Examples, the average Vickers hardness HV was not less than 1,500, but the fluctuation was large. Similarly, the fluctuation of the fracture toughness value was large.

Then, a durability test was performed using the bearing balls made of the silicon nitride sintered bodies according to the Examples and the Comparative Examples. The diameter of the bearing ball used was 9.525 mm (⅜ inches). The bearing ball was polished so that the surface roughness Ra was not more than 0.013 μm. A bearing was made by assembling sixteen bearing balls between an inner ring and an outer ring. The inner ring and the outer ring were made of bearing steel SUJ2. The durability and electrolytic corrosion resistance of each bearing were checked.

In the durability test, the bearing was continuously driven while changing the rotational speed. The conditions of the change of the rotational speed were as follows. One set was defined as “50 rpm for 1 hour”→“increase from 50 rpm to 2,000 rpm over 1 hour”→“2,000 rpm for 1 hour”→“increase from 2,000 rpm to 13,000 rpm over 1 hour”→“13,000 rpm for 1 hour”→“reduce from 13,000 rpm to 50 rpm over 1 hour”. The set was repeatedly performed. The sliding noise (dB) was measured when the continuous driving reached 100 hours, 400 hours, and 800 hours. The ratio of the sliding noise after 400 hours relative to the sliding noise after 100 hours and the ratio of the sliding noise after 800 hours relative to the sliding noise after 100 hours were calculated as increase rates of the sliding noise.

The silicon nitride sintered bodies for which the increase rate was not more than 10% were recorded as “excellent” (EX). The silicon nitride sintered bodies for which the increase rate was greater than 10% and less than 20% were recorded as “good” (G). The silicon nitride sintered bodies for which the increase rate was greater than 20% were recorded as “no-good” (NG). The test can determine changes in the sliding condition due to damage of the bearing ball or seizure of the bearing rings. The sliding noise measurement was performed in accordance with JIS-B-1548. For electrolytic corrosion resistance, the presence of electrolytic corrosion after running for 800 hours was checked. The results are shown in Table 6.

TABLE 6

| | |
|---|---|
| | Electrolytic |
| Sliding noise change rate | corrosion after |

| | 400 hours | 800 hours | 800 hours |
|---|---|---|---|
| Example1 | EX | EX | No |
| Example2 | EX | EX | No |
| Example3 | EX | EX | No |
| Example4 | EX | EX | No |
| Example5 | EX | EX | No |
| Example6 | EX | EX | No |
| Example7 | EX | EX | No |
| Example8 | EX | EX | No |
| Example9 | EX | EX | No |
| Example10 | EX | G | No |
| Example11 | EX | EX | No |
| Example12 | EX | EX | No |
| Example13 | EX | EX | No |
| Example14 | G | G | Yes |
| Example15 | G | G | Yes |
| Example16 | G | G | Yes |
| Example17 | EX | EX | No |
| Example18 | EX | EX | No |
| Example19 | EX | EX | No |
| Example20 | EX | EX | No |
| Example21 | EX | EX | No |
| Example22 | EX | EX | |
| Example23 | EX | EX | No |
| Comparative | G | NG | Yes |
| Example1 | | | |
| Comparative | G | NG | Yes |
| Example2 | | | |
| Comparative | G | NG | Yes |
| Example3 | | | |

The increase rate of the bearing ball sliding noise was suppressed for the Examples. The increase rate of the sliding noise after 800 hours was slightly larger for Examples 10 and 14 to 16 than for the other Examples. It is considered that this was caused by higher area ratios of white regions. Also, bearing ball electrolytic corrosion was suppressed for many Examples. This result showed that the embodiments improved the characteristics even for silicon nitride sintered bodies manufactured from silicon nitride powders having a high amount of impurities. For Examples 14 to 16, electrolytic corrosion was confirmed even though the wear resistance was good. This was due to a high impurity amount (the Fe amount, the Cr amount, or the Ca amount) compared to the other Examples. In contrast, for the Comparative Examples, the sliding noise increase rate after 800 hours was large. Electrolytic corrosion also was confirmed.

Embodiments of the invention include the following features.

### Feature 1

A silicon nitride sintered body,
XRD analysis results of any cross section of the silicon nitride sintered body satisfying 0.001≤(I_{20.5°}+I_{22.8°}+I_{34.3°}+I_{38.7°})/(I_{33.6°}+I_{36.1°})≤0.300 and satisfying 0.002≤(I_{31.8°}+I_{37.2°})/(I_{33.6°}+I_{36.1°})≤0.100,
I_{20.5°}, I_{2.8°}, I_{34.3°}, and I_{38.7°} being maximum peak intensities corresponding to hexagonal α-SiAION crystals detected respectively at 20.5±0.3°, 22.8±0.3°, 34.3±0.3°, and 38.7±0.3°,
I_{33.6°} and I_{36.1°} being maximum peak intensities corresponding to β-Si₃N₄ crystals detected respectively at 33.6±0.3° and 36.1±0.3°,
I_{31.8°} and I_{37.2°} being maximum peak intensities corresponding to R₂Si₃O₃N₄ crystals detected respectively at 31.8±0.3° and 37.2±0.3°,
R being a rare-earth element.

### Feature 2

The silicon nitride sintered body according to Feature 1, further comprising R₄Al₂O₉ crystals,
the XRD analysis results satisfying 0≤(I_{19.1°}+I_{31.0°}+I_{32.5°})/(I_{33.6°}+I_{36.1°})≤0.100,
R being a rare-earth element,
I_{19.1°}, I_{31.0°}, and I_{32.5°} being maximum peak intensities corresponding to R₄Al₂O₉ crystals detected respectively at 19.1±0.3°, 31.0±0.3°, and 32.5±0.3°.

### Feature 3

The silicon nitride sintered body according to Feature 1 or Feature 2, further comprising titanium nitride,
the XRD analysis results satisfying 0.020≤(I_{36.5°}+I_{42.4°})/(I_{33.6°}+I_{36.1°})≤0.050,
I_{36.5°} and I_{42.4°} being maximum peak intensities corresponding to titanium nitride detected respectively at 36.5±0.3° and 42.4±0.3°.

### Feature 4

The silicon nitride sintered body according to any one of Features 1 to 3, wherein
in the XRD analysis results, an XRD peak based on R₃Al₅O₁₂ crystals and an XRD peak based on RAlO₃ crystals are not detected, or are below a detection limit of the XRD analysis results.

### Feature 5

The silicon nitride sintered body according to any one of Features 1 to 4, wherein
the silicon nitride sintered body includes:
   not less than 3 mass % and not more than 7 mass % of Al; and
   not less than 2 mass % and not more than 8 mass % of a rare-earth element.

### Feature 6

The silicon nitride sintered body according to any one of Features 1 to 5, wherein
the silicon nitride sintered body has a content of iron within a range of not less than 10 wtppm and not more than 3,000 wtppm.

### Feature 7

The silicon nitride sintered body according to any one of Features 1 to 6, wherein
when the cross section is observed with a laser microscope, an area ratio of white regions in a measurement area of 4,000 μm×4,000 μm is not more than 70%.

### Feature 8

The silicon nitride sintered body according to any one of Features 1 to 7, wherein
when the cross section is observed with SEM, a plurality of crystal grains having a major diameter of not less than 2.5 μm and an aspect ratio of not less than 2.5 are present in a measurement area of 20 μm×15 μm, and
a total area ratio of the plurality of crystal grains is within a range of not less than 20% and not more than 70%.

### Feature 9

The silicon nitride sintered body according to any one of Features 1 to 8, wherein
a Vickers hardness HV of the silicon nitride sintered body is not less than 1,500.

### Feature 10

The silicon nitride sintered body according to any one of Features 1 to 9, wherein
a fracture toughness value of the silicon nitride sintered body is not less than 6.0 MPa·m^{1/2}.

### Feature 11

A wear-resistant member using the silicon nitride sintered body according to any one of Features 1 to 10.

### Feature 12

The wear-resistant member according to Feature 11, wherein
the wear-resistant member is a bearing ball.

While certain embodiments of the invention have been illustrated, the embodiments are presented as examples, and are not intended to limit the scope of the inventions. These novel embodiments may be embodied in a variety of other forms; and various omissions, substitutions, modifications, etc., can be made without departing from the spirit of the inventions. These embodiments and their modifications are within the scope and spirit of the inventions, and are within the scope of the inventions described in the claims and their equivalents. The embodiments above can be implemented in combination with each other.

What is claimed is:

1. A silicon nitride sintered body,
XRD analysis results of any cross section of the silicon nitride sintered body satisfying 0.001≤(I_{20.5°}+I_{22.8°}+I_{34.3°}+I_{38.7°})/(I_{33.6°}+I_{36.1°})≤0.300 and satisfying 0.002≤(I_{31.8°}+I_{37.2°})/(I_{33.6°}+I_{36.1°})≤0.100,
I_{20.5°}, I_{22.8°}, I_{34.3°}, and I_{38.7°} being maximum peak intensities corresponding to hexagonal α-SiAION crystals detected respectively at 20.5±0.3°, 22.8±0.3°, 34.3±0.3°, and 38.7±0.3°,
I_{33.6°} and I_{36.1°} being maximum peak intensities corresponding to β-Si₃N₄ crystals detected respectively at 33.6±0.3° and 36.1±0.3°,
I_{31.8°} and I_{37.2°} being maximum peak intensities corresponding to R₂Si₃O₃N₄ crystals detected respectively at 31.8±0.3° and 37.2±0.3°.

2. The silicon nitride sintered body according to claim 1, further comprising R₄Al₂O₉ crystals,
the XRD analysis results satisfying 0≤(I_{19.1°}+I_{31.0°}+I_{32.5°})/(I_{33.6°}+I_{36.1°})≤0.100,
R being a rare-earth element,
I_{19.1°}, I_{31.0°}, and I_{32.5°} being maximum peak intensities corresponding to R₄Al₂O₉ crystals detected respectively at 19.1±0.3°, 31.0±0.3°, and 32.5±0.3°.

3. The silicon nitride sintered body according to claim 1, further comprising titanium nitride,
the XRD analysis results satisfying 0.020≤(I_{36.5°}+I_{42.4°})/(I_{33.6°}+I_{36.1°})≤0.050,
I_{36.5°} and I_{42.4°} being maximum peak intensities corresponding to titanium nitride detected respectively at 36.5±0.3° and 42.4±0.3°.

4. The silicon nitride sintered body according to claim 1, wherein
in the XRD analysis results, an XRD peak based on R₃Al₅O₁₂ crystals and an XRD peak based on RAlO₃ crystals are not detected, or are below a detection limit of the XRD analysis results.

5. The silicon nitride sintered body according to claim 3, wherein
in the XRD analysis results, an XRD peak based on R₃Al₅O₁₂ crystals and an XRD peak based on RAlO₃ crystals are not detected, or are below a detection limit of the XRD analysis results.

6. The silicon nitride sintered body according to claim 1, wherein
the silicon nitride sintered body includes:
not less than 3 mass % and not more than 7 mass % of Al; and
not less than 2 mass % and not more than 8 mass % of a rare-earth element.

7. The silicon nitride sintered body according to claim 5, wherein
the silicon nitride sintered body includes:
not less than 3 mass % and not more than 7 mass % of Al; and
not less than 2 mass % and not more than 8 mass % of a rare-earth element.

8. The silicon nitride sintered body according to claim 1, wherein
the silicon nitride sintered body has a content of iron within a range of not less than 10 wtppm and not more than 3,000 wtppm.

9. The silicon nitride sintered body according to claim 5, wherein
the silicon nitride sintered body has a content of iron within a range of not less than 10 wtppm and not more than 3,000 wtppm.

10. The silicon nitride sintered body according to claim 1, wherein
when the cross section is observed with a laser microscope, an area ratio of white regions in a measurement area of 4,000 μm×4,000 μm is not more than 70%.

11. The silicon nitride sintered body according to claim 1, wherein
when the cross section is observed with SEM, a plurality of crystal grains having a major diameter of not less than 2.5 μm and an aspect ratio of not less than 2.5 are present in a measurement area of 20 μm×15 μm, and
a total area ratio of the plurality of crystal grains is within a range of not less than 20% and not more than 70%.

12. The silicon nitride sintered body according to claim 6, wherein
when the cross section is observed with SEM, a plurality of crystal grains having a major diameter of not less than 2.5 μm and an aspect ratio of not less than 2.5 are present in a measurement area of 20 μm×15 μm, and
a total area ratio of the plurality of crystal grains in the measurement area is within a range of not less than 20% and not more than 70%.

13. The silicon nitride sintered body according to claim 7, wherein
when the cross section is observed with SEM, a plurality of crystal grains having a major diameter of not less than 2.5 μm and an aspect ratio of not less than 2.5 are present in a measurement area of 20 μm×15 μm, and
a total area ratio of the plurality of crystal grains in the measurement area is within a range of not less than 20% and not more than 70%.

14. The silicon nitride sintered body according to claim 1, wherein
a Vickers hardness HV of the silicon nitride sintered body is not less than 1,500.

15. The silicon nitride sintered body according to claim 1, wherein
a fracture toughness value of the silicon nitride sintered body is not less than 6.0 MPa·m^{1/2}.

16. A wear-resistant member using the silicon nitride sintered body according to claim 1.

17. A wear-resistant member using the silicon nitride sintered body according to claim 14.

18. The wear-resistant member according to claim 16, wherein
the wear-resistant member is a bearing ball.
